(19) United States
(12) Patent Application Publication
(10) Pub. No.: US 2024/0163834 A1
(43) Pub. Date: May 16, 2024

(54) CONFIGURING A POSITIONING REFERENCE SIGNAL TYPE

(71) Applicant: Lenovo (Singapore) Pte. Ltd., New Tech Park (SG)

(72) Inventors: Karthikeyan Ganesan, Kronberg im Taunus (DE); Robin Thomas, Bad Nauheim (DE); Ankit Bhamri, Rödermark (DE); Ali Ramadan Ali, Kraiburg am Inn (DE)

(21) Appl. No.: 18/550,864

(22) PCT Filed: Mar. 11, 2022
(86) PCT No.: PCT/IB2022/052228

§ 371 Date: Sep. 15, 2023

Related U.S. Application Data
(60) Provisional application No. 63/161,819, filed on Mar. 16, 2021.

(51) Int. Cl. H04W 64/00; H04J 13/00; H04L 1/1812; H04L 5/00; H04W 72/232

(52) U.S. Cl. CPC H04W 64/00; H04J 13/0062; H04L 1/1812; H04L 5/0051; H04W 72/232

(57) ABSTRACT

Apparatuses, methods, and systems are disclosed for configuring a positioning reference signal type. One method includes receiving, at a user equipment (UE), a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. The method includes transmitting a ranging signal to at least one device, receiving a ranging signal from at least one device, or some combination thereof.

### CROSS-REFERENCE TO RELATED APPLICATIONS

This application claims priority to U.S. Patent Application Ser. No. 63/161,819 entitled “APPARATUSES, METHODS, AND SYSTEMS FOR PRS MAPPING CONFIGURATION AND SIGNALING OF FREQUENCY DOMAIN REPETITION” and filed on Mar. 16, 2021 for Karthikeyan Ganesan, which is incorporated herein by reference in its entirety.

### FIELD

The subject matter disclosed herein relates generally to wireless communications and more particularly relates to configuring a positioning reference signal type.

### BACKGROUND

In certain wireless communications networks, UE-assisted and UE-based positioning methods may be used. In such networks, ranging in such methods may not be efficient.

### BRIEF SUMMARY

Methods for configuring a positioning reference signal type are disclosed. Apparatuses and systems also perform the functions of the methods. One embodiment of a method includes receiving, at a user equipment (UE), a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In some embodiments, the method includes transmitting a ranging signal to at least one device, receiving a ranging signal from at least one device, or some combination thereof.

One apparatus for configuring a positioning reference signal type includes a user equipment (UE). In some embodiments, the apparatus includes a receiver that receives a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof, or some combination thereof. In various embodiments, the apparatus includes a transmitter that transmits a ranging signal to at least one device, receiving a ranging signal from at least one device, or some combination thereof.

Another embodiment of a method for configuring a positioning reference signal type includes transmitting, from a network device, a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In some embodiments, the method includes receiving a ranging signal to at least one device, transmitting a ranging signal from at least one device, or some combination thereof.

Another apparatus for configuring a positioning reference signal type includes a network device. In some embodiments, the apparatus includes a transmitter that transmits a configuration for transmission of at least one positioning reference signal (PRS) type. The configuration includes at least one parameter including: a PRS bandwidth; a number of time domain symbol for PRS transmission in a slot; a mapping type including at least one Zadoff-chu sequence length for: at least one frequency domain repetition; a number of repetitions; a cyclic shift; or some combination thereof, or some combination thereof. In various embodiments, the apparatus includes a receiver that receives a ranging signal to at least one device, transmitting a ranging signal from at least one device, or some combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a positioning reference signal type;

FIG. 2 is a schematic block diagram illustrating one embodiment of an apparatus that may be used for configuring a positioning reference signal type;

FIG. 3 is a schematic block diagram illustrating one embodiment of an apparatus that may be used for configuring a positioning reference signal type;

FIGS. 4A and 4B are schematic block diagrams illustrating one embodiment of a system for showing repetition of a Zadoff-chu sequence in a frequency domain;

FIG. 5 is a schematic block diagram illustrating one embodiment of a system for showing block repetition of a Zadoff-chu sequence in a frequency domain;

FIGS. 6A and 6B are schematic block diagrams illustrating one embodiment of a system for showing block repetition of a Zadoff-chu sequence in a frequency domain with different sequence lengths;

FIG. 7 is a flow chart diagram illustrating one embodiment of a method for configuring a positioning reference signal type; and

FIG. 8 is a flow chart diagram illustrating another embodiment of a method for configuring a positioning reference signal type.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

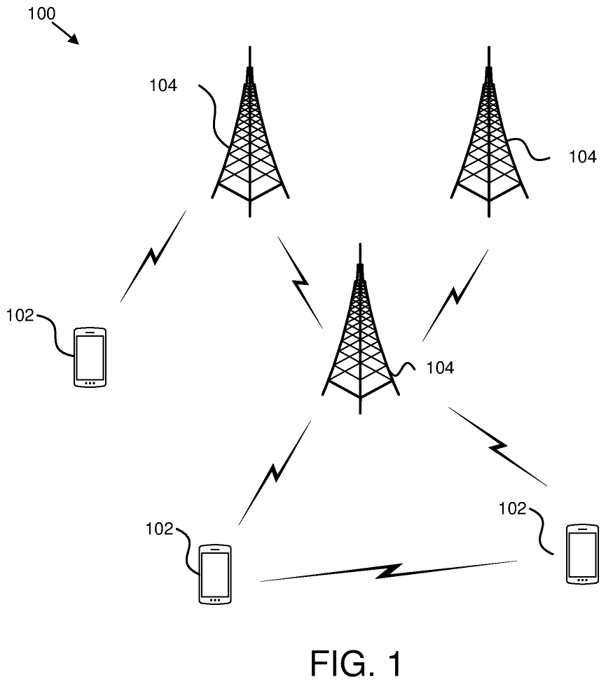

FIG. 1 depicts an embodiment of a wireless communication system 100 for configuring a positioning reference signal type. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a user equipment (UE), a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In some embodiments, the remote unit 102 may transmit a ranging signal to at least one device, receiving a ranging signal from at least one device, or some combination thereof. Accordingly, the remote unit 102 may be used for configuring a positioning reference signal type.

In certain embodiments, a network unit 104 may transmit, from a network device, a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In some embodiments, the network unit 104 may receive a ranging signal to at least one device, transmitting a ranging signal from at least one device, or some combination thereof. Accordingly, the network unit 104 may be used for configuring a positioning reference signal type.

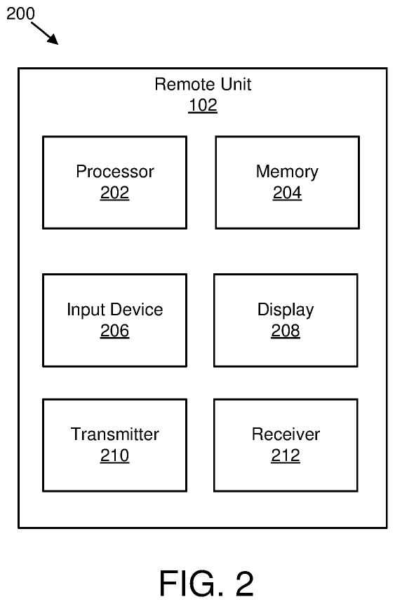

FIG. 2 depicts one embodiment of an apparatus 200 that may be used for configuring a positioning reference signal type. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In various embodiments, the transmitter 210 transmits a ranging signal to at least one device, receiving a ranging signal from at least one device, or some combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

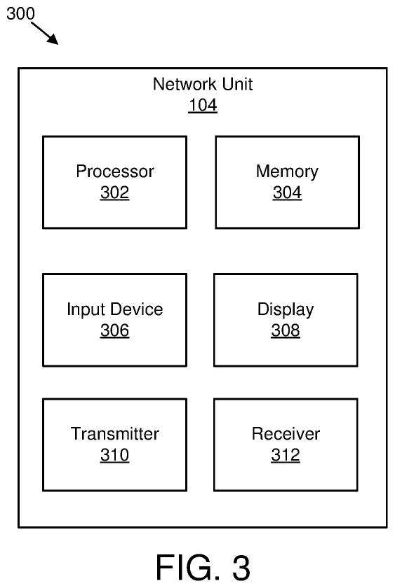

FIG. 3 depicts one embodiment of an apparatus 300 that may be used for configuring a positioning reference signal type. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits a configuration for transmission of at least one positioning reference signal (PRS) type. The configuration includes at least one parameter including: a PRS bandwidth; a number of time domain symbol for PRS transmission in a slot; a mapping type including at least one Zadoff-chu sequence length for: at least one frequency domain repetition; a number of repetitions; a cyclic shift; or some combination thereof or some combination thereof. In various embodiments, the receiver 312 receives a ranging signal to at least one device, transmitting a ranging signal from at least one device, or some combination thereof.

It should be noted that one or more embodiments described herein may be combined into a single embodiment.

In certain embodiments, a 3GPP positioning framework may enable user equipment (“UE”)-assisted and UE-based positioning methods. In such embodiments, there may be a lack of support for efficient UE-to-UE ranging determination. UE-to-UE ranging determination may be important to support relative positioning applications. In some embodiments, there may be a ranging signal configuration for transmission of different positioning reference signals (“PRS”) types which offers high-precision accuracy for determining the range and relative orientation between UEs.

In various embodiments, radio access technology (“RAT”)-dependent positioning methods such as time difference of arrival (“TDOA”), multi round trip time (“RTT”), downlink (“DL”) angle of departure (“AoD”) (“DL-AoD”) and/or uplink (“UL”) angle of arrival (“AoA”) (“UL-AoA”) and cell identifier (“ID”) (“CID”) and/or enhanced (“E”) CID (“E-CID”) may be used for UE to network (“Uu”) interface in LTE and new radio (“NR”). These positioning techniques show high potential for application in sidelink (“SL”), although there may not be methods to realize such implementations in 3GPP using a pulse-based ranging waveform. In certain embodiments, a set ID (“SID”) includes: 1) identifying positioning use cases and requirements for vehicle to everything (“V2X”) and public safety based on 3GPP work and input; and/or 2) identifying potential deployment and operation scenarios.

In various embodiments, there may be mapping options for PRS type 2 based on a Zadoff-chu sequence serving a variety of PRS-based channel impulse response (“CIR”) estimation types such as least square estimate, auto correlation, super resolution, and so forth. In certain embodiments, autonomous resource selection may include a time and/or frequency resource and cyclic shifts for PRS type 2 transmission.

In some embodiments, there may be configuration, mapping, frequency domain repetition, and signaling for PRS type 2 (e.g., Zadoff-chu sequence). In various embodiments, an autonomous resource selection procedure for different PRS types may include: 1) PRS type 1—pseudo random sequence (e.g., based on a gold sequence); and/or 2) PRS type 2—Zadoff-chu sequence (e.g., generalized chirp-like sequence).

In certain embodiments, a resource selection and/or reselection trigger contains an input parameter to specify a PRS type and/or a PRS resource type for candidate resource selection, where the PRS resource type may be a time and/or frequency resource and/or a cyclic shift.

In some embodiments, a controller refers to a device that controls a ranging session and defines ranging parameters by sending ranging control information (e.g., in a ranging control message). In various embodiments, a controlee refers to a device that uses ranging parameters received from a controller by decoding a ranging control message.

In certain embodiments, an initiator device, following a transmission and/or reception of a ranging control message, transmits a first ranging message exchange. In some embodiments, a responder device responds to an initial ranging message received from an initiator.

In a first embodiment, a wide bandwidth PRS transmission is essential for the accuracy of a positioning estimate and to achieve wider bandwidth PRS transmission. A Zadoff-chu sequence based PRS may have a variety of mapping types defined, such as: 1) a mapping of a single long PRS sequence length over a wide PRS bandwidth and/or mapping one or more short PRS sequence lengths and repetitions in the frequency domain to cover the wide PRS bandwidth; and/or 2) each of the mappings may serve different types of receiver implementations such as least square error (“LSE”), auto correlation, and/or super resolution.

In some embodiments, a plurality of Zadoff-chu configurations including sequence length may be configured for sidelink PRS transmission, such a PRS Type 2 configuration may be configured in one or more combination as follows: 1) a UE and a gNB may exchange supported Zadoff-chu configurations including sequence length, repetitions, and/or cyclic shifts; 2) a gNB and a location management function (“LMF”) may exchange supported Zadoff-chu configurations including sequence length, repetitions, and/or cyclic shifts; and/or 3) a UE may be preconfigured with a default Zadoff-chu configuration at a previous time instance to be used at a later stage. Any updated Zadoff-chu configuration may overwrite the preconfigured configuration stored within the UE.

In various embodiments, a resource pool, a positioning frequency layer, and/or a carrier may be configured with a plurality of Zadoff-chu sequence lengths for autonomous resource selection for PRS; otherwise, a configuration from LMF involves LTE positioning protocol (“LPP”) signaling through a NR positioning protocol annex (“NRPPa”) interface indicating a Zadoff-chu sequence length, a repetition in the frequency domain, a cyclic shift, a PRS bandwidth, and so forth. In certain embodiments, a mode 1 grant contains a Zadoff-chu sequence length, a cyclic shift, a PRS bandwidth, a repetition in a frequency domain and time domain allocation. In some embodiment, UE to UE (“PC5”) interface radio resource control (“RRC”) may be used to signal one or more parameters to receive (“RX”) UEs.

In certain embodiments, there may be a first mapping type in which a single long PRS sequence length is mapped in one or more-time domain symbol over a wide PRS bandwidth. This may be beneficial to support a high number of nodes multiplexed with different cyclic shifts and for better time resolution of a channel impulse response (“CIR”). In one implementation, a Zadoff-chu sequence may be mapped in one-time domain symbol starting from a first subcarrier (e.g., in a starting physical resource block (“PRB”) in a subchannel or after the first and/or second sidelink control information (“SCI”)) in a frequency first manner if the sequence length is equal or less than a signaled PRS bandwidth. For example, a sequence could be mapped from a symbol #0-subcarrier #0 . . . subcarrier #N, where N may be Zadoff-chu sequence length. In another implementation, a Zadoff-chu sequence may be mapped as a frequency first and time second manner in a plurality of time domain symbol if a sequence length is greater than a number of available REs for PRS mapping in a symbol and/or signaled PRS bandwidth. The Zadoff-chu sequence may be mapped from a starting PRB in a subchannel or after the first and/or second SCI. For example, a sequence may be mapped from the symbol #0-subcarrier #0 . . . subcarrier #N, symbol #1-subcarrier #0 . . . subcarrier #N, where N is the segmented sequence length in each time domain symbol.

In some embodiments, there may be a second mapping type in which there may be a repetition of a same and/or similar Zadoff-chu sequence in a frequency domain for wide PRS transmissions and/or a plurality of repetition in the frequency domain containing one or more Zadoff-chu sequences length, where one or more repetitions from the similar and/or the same Zadoff-chu sequence in the frequency domain may be grouped. This may be beneficial for reducing receiver complexity and for multiplexing nodes in the frequency domain.

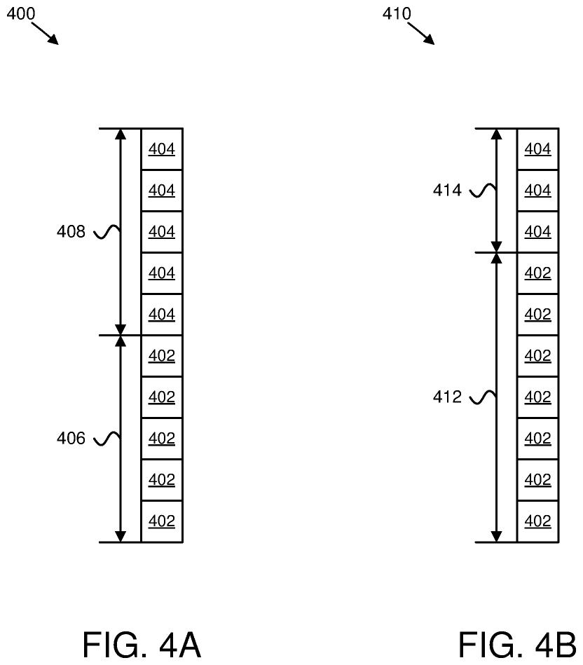

In one implementation, the same and/or the similar Zadoff-chu sequence having the same cyclic shift may be one or more times repeated in the frequency domain (e.g., FIG. 4A) to cover the PRS bandwidth in each PRS occasion in the time domain. A number of repetitions, a sequence length, a cyclic shift, and/or a PRS bandwidth are signaled to a UE.

FIGS. 4A and 4B are schematic block diagrams illustrating one embodiment of a system for showing repetition of a Zadoff-chu sequence in a frequency domain. In FIG. 4A, a Zadoff-chu sequence repetition 400 includes first resource elements 402 and second resource elements 404. FIG. 4A includes a first repetition 406 of a Zadoff-chu sequence having a first length, and a second repetition 408 of a Zadoff-chu sequence having the same first length. In FIG. 4B, a Zadoff-chu sequence repetition 410 includes first resource elements 402 and second resource elements 404. FIG. 4B includes a first repetition 412 of a Zadoff-chu sequence having a first length, and a second repetition 414 of a Zadoff-chu sequence having a second length.

In another implementation, one or more repetitions in the frequency domain could be performed with different Zadoff-chu sequence lengths (e.g., FIG. 4B) to cover the PRS bandwidth in each PRS occasion in the time domain. If a PRS bandwidth is not a multiple of a sequence length, a last repetition may be performed with a different sequence length.

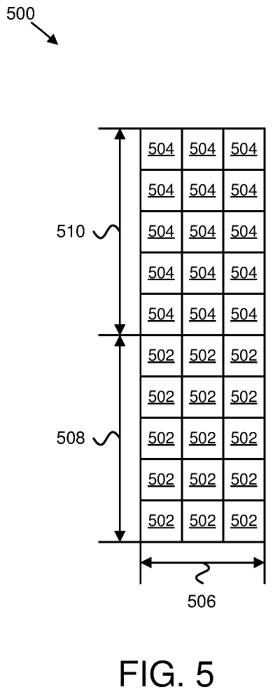

In a further implementation, one or more repetition blocks include N symbols and M PRBs and/or subchannels in a frequency domain as shown in the FIG. 5. In each block, a Zadoff-chu sequence is mapped starting with frequency first and then time next.

FIG. 5 is a schematic block diagram illustrating one embodiment of a system for showing block repetition of a Zadoff-chu sequence 500 in a frequency domain. In FIG. 5, a block repetition of a Zadoff-chu sequence 500 includes first resource elements 502 and second resource elements 504 over a first PRS occasion 506 time period. FIG. 5 includes a first block repetition 508 of a Zadoff-chu sequence having a first length, and a second block repetition 510 of a Zadoff-chu sequence having the same first length.

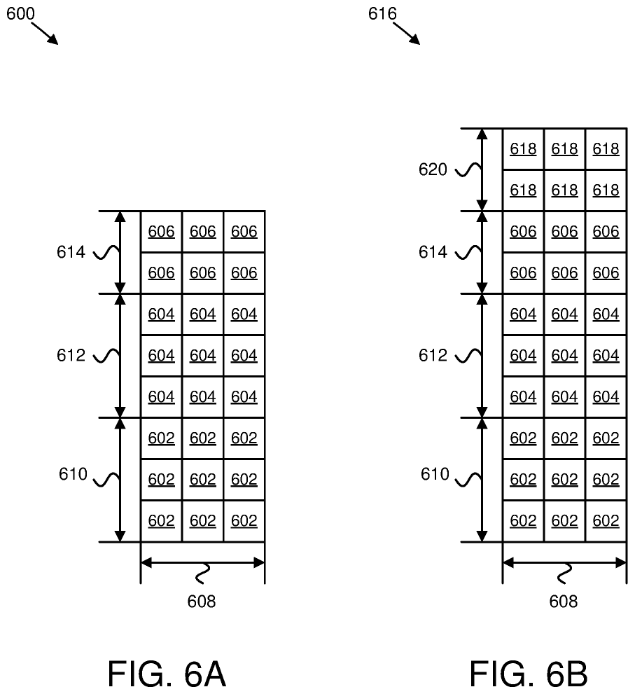

In one implementation, one or more repetition block of different sequence lengths include N symbols and M PRBs and/or subchannels in the frequency domain as shown in the FIGS. 6A and 6B in each PRS occasion. In each block, a Zadoff-chu sequence is mapped starting with frequency first and then time next. In FIGS. 6A and 6B, a repetition block including a same and/or a similar sequence length may be grouped. If a PRS bandwidth is not a multiple of a sequence length of a last repetition or a last set of repetition, it may be performed with a different sequence length. In another implementation, in each block a Zadoff-chu sequence may be mapped starting with time first and then frequency next. In certain implementations, a PRS sequence or a PRS block may be interlaced in a frequency domain and each interfacing block may be ‘M’ PRBs or ‘M’ subchannels or ‘M’ REs. For example, a first PRS sequence intended for transmission to a first node is repeated in frequency-time in a distributed and/or interlaced manner along with a second PRS sequence intended for transmission to a first node using the same time an/dor frequency resource but different cyclic shifts.

FIGS. 6A and 6B are schematic block diagrams illustrating one embodiment of a system for showing block repetition of a Zadoff-chu sequence in a frequency domain with different sequence lengths. In FIG. 6A, block repetition of a Zadoff-chu sequence 600 includes first resource elements 602, second resource elements 604, and third resource elements 606 over a first PRS occasion 608 time period. FIG. 6A includes a first repetition 610 of a Zadoff-chu sequence having a first length, a second repetition 612 of a Zadoff-chu sequence having the same first length, and a third repetition 614 of a Zadoff-chu sequence having a second length different from the first length. In FIG. 6B, block repetition of a Zadoff-chu sequence 616 includes first resource elements 602, second resource elements 604, third resource elements 606, and fourth resource elements 618 over the first PRS occasion 608 time period. FIG. 6B includes the first repetition 610 of a Zadoff-chu sequence having a first length and the second repetition 612 of a Zadoff-chu sequence having the same first length. Both of the first repetition 610 and the second repetition 612 are part of a first group. FIG. 6B also includes the third repetition 614 of a Zadoff-chu sequence having a second length different from the first length and a fourth repetition 620 of a Zadoff-chu sequence having the second length. Both of the third repetition 614 and the fourth repetition 620 are part of a second group.

In certain embodiments, different mapping types, including a length of a sequence and a number of repetitions, can be configured depending on a positioning scenario including a number of nodes involved in determining a target UE's absolute or relative location estimate (e.g., in the case of TDOA positioning techniques where at least three anchor nodes are required), the second mapping type configuration may be suitable in terms of reduced PRS Type 2 interference at the UE arising from different anchor nodes. In one example, for the case of UE-to-UE positioning, an implementation of the second mapping type includes spreading the Zadoff-chu sequence across symbols in time that may enhance a channel impulse response resulting in enhanced detection of a first path for positioning techniques such as single sided (“SS”) RTT (“SS-RTT”) or double sided (“DS”) RTT (“DS-RTT”).

In one implementation, a PRS Type 2 mapping type may be dependent of positioning and/or ranging service parameters, which may include one or more combinations of the following: 1) horizontal and vertical accuracy which can be an absolute and/or a vertical accuracy; 2) an end-to-end latency—including a desired positioning latency budget, a time to first fix (“TTFF”), and/or a physical layer latency—for example, for extremely low-latency requirements, repetition of PRS sequence is done on a frequency first basis and a time second basis; and/or desired positioning techniques (e.g., DL-TDOA, RTT, AoA, and/or AoD methods).

In some embodiments, a UE may be configured with a mapping table indicating for which scenarios, configurations, accuracy, and/or latency requirements, a PRS mapping type is to be used. In one implementation, different thresholds for a number of subcarriers is configured according to which a UE can determine which PRS mapping to use. In one example, there is an implied mapping of a PRS sequence to a number of subcarriers, wherein the number of subcarriers may be determined based on a configured bandwidth for PRS and a numerology (e.g., subcarrier spacing value) for PRS transmission.

In various embodiment, a sequence is generated in a time domain and mapped to some configured symbols after an inverse fast Fourier transform (“IFFT”). A UE performs auto correlation on a received sequence to estimate a CIR and calculate a TDoA in a time domain. In one implementation, a sequence is one symbol in length repeated in a time domain on an N number of symbols. In another implementation, a single sequence spans multiple orthogonal frequency division multiplexing (“OFDM”) symbols.

In certain embodiments, frequency domain assignment contains PRS bandwidth and a time domain resource allocation (“TDRA”) table contain columns indicating a number of time domain symbol for PRS transmission in a slot, a Zadoff-chu sequence length—sequence length to be applied in each repetition, a type of repetitions, a frequency domain, a time domain, a combination of both the frequency domain and the time domain, a number of repetitions in the frequency domain and/or the time domain, and/or separately indicate in downlink control information (“DCI”) a second Zadoff-chu sequence length for a second set of repetition in the frequency domain. In some embodiments, a cyclic shift is signaled separately in a DCI field and some of the unused fields for PRS (e.g., hybrid automatic repeat request (“HARQ”) process number) may be used to indicate cyclic shift.

In one implementation, a configuration may be signaled from LMF involves LPP signaling through an NRPPa interface. In another implementation, SCI contains one or more parameters signaled to an RX UE. In a further implementation, a mode-1 grant from a gNB and/or an LMF may indicate a type of repetition and/or a PRS bandwidth while a transmit (“TX”) UE may autonomously select one or more PRS sequence lengths from a set of configured sequence lengths from a resource pool, SL bandwidth part (“BWP”), and/or SL carrier for transmission during each repetition and signaled in SCI.

In some embodiment, a TX UE expects that a PRS bandwidth is in multiples of a PRS sequence length to avoid transmitting a truncated Zadoff-chu sequence. If the PRS bandwidth is not a multiple of a PRS sequence length, a UE is not expected to transmit a last repetition in a frequency domain with a truncated sequence length. In one implementation, a last repetition may be transmitted using a different sequence length to accommodate a PRS bandwidth.

In various embodiments, an RX UE may signal a receiver type or type of PRS to a TX UE as part of an inter-UE coordination message, PC5 RRC, MAC CE, or SCI. In certain embodiments, a mode 1 grant from a gNB and/or a LMF may indicate a PRS type and/or a PRS mapping type as part of a configuration message to a TX UE.

In some embodiments, a configured grant (“CG”) configuration may include a PRS type and/or a PRS mapping type, and there may be a separate CG configuration for each of the PRS types and/or PRS mapping types. In various embodiments, a resource pool configuration, SL BWP, and/or SL carrier may contain a PRS type and/or a PRS mapping type. In certain embodiments, a PRS configuration may be transmitted from a gNB or from a LMF may contain a PRS type and/or a PRS mapping type.

In a second embodiment, a resource selection and/or reselection trigger may contain one or more input parameters to aid sensing, candidate resource selection, candidate resource exclusion, resource evaluation, resource reevaluation, and/or one or more input parameters may be part of a short term sensing parameter. One or more higher layer input parameters as part of a resource selection and/or reselection trigger may contain PRS type, PRS resource type, and/or PRS bandwidth for candidate resource selection and/or exclusion procedure. A PRS resource type may indicate a preference of a candidate resource from a TX UE. Moreover, the TX UE may transmit PRS in any free time and/or frequency resource (e.g., a free time and/or frequency (“T/F”) resource may be a resource below a reference signal received power (“RSRP”) threshold); otherwise, the TX UE may multiplex using a cyclic shift in any occupied T/F resource (e.g., RSRP above threshold) since a cyclic shift may create an additional dimension for an orthogonal transmission of a PRS sequence in any occupied T/F resource (e.g., whose RSRP value is above a threshold). A TX UE may indicate a preference as part of a resource selection trigger which provides an input for a candidate resource selection algorithm to find any free T/F resource or free cyclic shift. In one implementation, a TX UE may report one candidate resource set containing T/F resources whose measured RSRP is below a certain configured threshold (e.g., free resource) and another candidate resource set containing cyclic shift to be used in a corresponding T/F resource. In another implementation, a TX UE may report T/F resource whose RSRP value is above a certain threshold (e.g., occupied threshold) and a corresponding set containing an available cyclic shift to be used (e.g., an orthogonal sequence is generated only with distinct cyclic shifts). In a further implementation, a UE reports only an available cyclic shift. Moreover, a MAC randomly selects a cyclic shift and/or T/F for PRS transmission.

In some embodiments, an input of PRS type 1 might report either a candidate resource set containing a T/F resource, a PRS comb pattern, a PRS frequency offset to use, and/or a muting pattern while a PRS type 2 might report candidate resource set contains cyclic shifts necessary for a corresponding T/F resource.

In various embodiments, a UE performs resource evaluation and/or reevaluation by checking a selected and/or preselected cyclic shift and/or T/F resource by monitoring SCI from other neighboring UEs and checking if there is any overlap in terms of T/F resource and/or cyclic shift and performs selection and/or reselection of cyclic shifts from a candidate set.

In certain embodiments, a UE performs short term sensing of ‘n’ duration and/or time slots from a beginning of a resource selection and/or reselection trigger (e.g., x to x+n) for a candidate resource set. In some embodiment, a UE randomly select a cyclic shift and a time frequency resource.

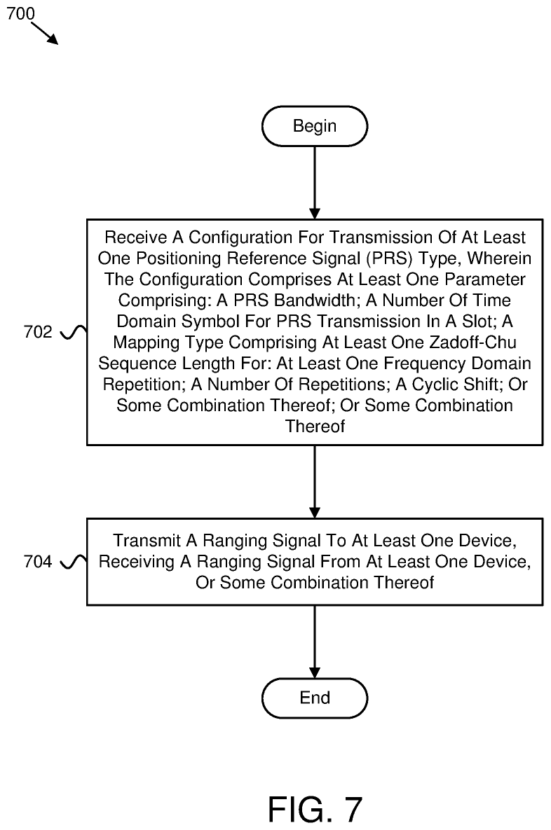

FIG. 7 is a flow chart diagram illustrating one embodiment of a method 700 for configuring a positioning reference signal type. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a user equipment (UE), a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In some embodiments, the method 700 includes transmitting 704 a ranging signal to at least one device, receiving a ranging signal from at least one device, or some combination thereof.

In certain embodiments, a long PRS sequence length is mapped in at least one domain symbol over a wide PRS bandwidth, and the at least one Zadoff-chu sequence is mapped via frequency first and time second. In some embodiments, a repetition of a substantially similar Zadoff-chu sequence in a frequency domain for wide PRS transmissions, a plurality of repetitions in the frequency domain containing the at least one Zadoff-chu sequence length, or a combination thereof are grouped together. In various embodiments, at least one repetition of the plurality of repetitions is performed using at least one different sequence length if a PRS bandwidth is not a multiple of a sequence length, and a last repetition of the plurality of repetitions is performed with a different sequence length.

In one embodiment, at least one repetition of the plurality of repetitions comprises N time domain symbols and M PRBs in the frequency domain, and each of the at least one repetition, each Zadoff-chu sequence of the at least one Zadoff-chu is mapped via frequency first and time second. In certain embodiments, a resource pool, a positioning frequency layer, a carrier, or some combination thereof is configured with the at least one Zadoff-chu sequence length for autonomous resource selection for PRS. In some embodiments, a first mode comprises the at least one Zadoff-chu sequence length, the cyclic shift, the PRS bandwidth, a repetition in a frequency domain and a time domain allocation, or some combination thereof.

In various embodiments, a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth. In one embodiment, a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof. In certain embodiments, the method 700 further comprises repeating, in the frequency domain, substantially similar Zadoff-chu sequences having the same cyclic shift.

In some embodiments, the method 700 further comprises interlacing a PRS sequence, a PRS block, or a combination thereof in the frequency domain into a plurality of interfacing blocks, and each interfacing block of the plurality of interfacing blocks comprises M PRBs, M subchannels, M REs, or some combination thereof. In various embodiments, repetitions of the at least one Zadoff-chu sequence comprise different sequence lengths in a frequency domain. In one embodiment, the method 700 further comprises receiving cyclic shift in a downlink control information (DCI) field, wherein the DCI field comprises a hybrid automatic repeat request (HARQ) process number field for PRS.

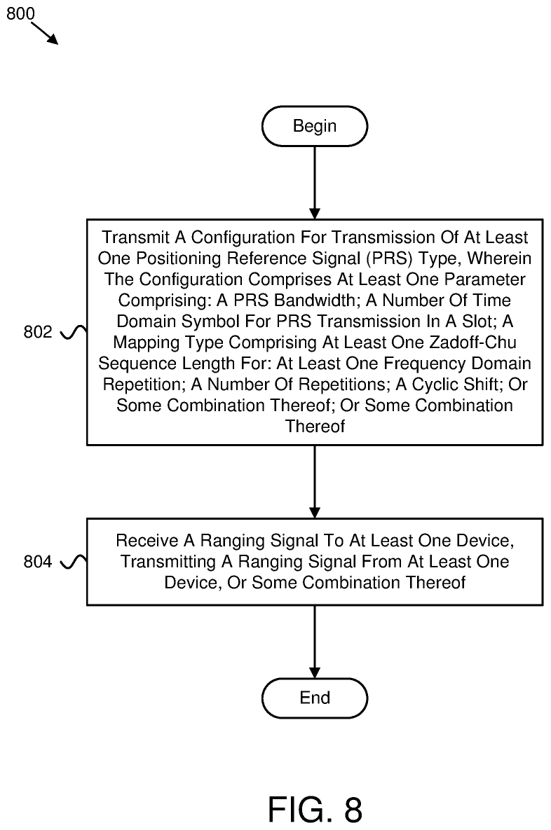

FIG. 8 is a flow chart diagram illustrating another embodiment of a method 800 for configuring a positioning reference signal type. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802, from a network device, a configuration for transmission of at least one positioning reference signal (PRS) type. The configuration includes at least one parameter including: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof. In some embodiments, the method 800 includes receiving 804 a ranging signal to at least one device, transmitting a ranging signal from at least one device, or some combination thereof.

In certain embodiments, a long PRS sequence length is mapped in at least one domain symbol over a wide PRS bandwidth, and the at least one Zadoff-chu sequence is mapped via frequency first and time second. In some embodiments, a repetition of a substantially similar Zadoff-chu sequence in a frequency domain for wide PRS transmissions, a plurality of repetitions in the frequency domain containing the at least one Zadoff-chu sequence length, or a combination thereof are grouped together. In various embodiments, at least one repetition of the plurality of repetitions is performed using at least one different sequence length if a PRS bandwidth is not a multiple of a sequence length, and a last repetition of the plurality of repetitions is performed with a different sequence length.

In one embodiment, at least one repetition of the plurality of repetitions comprises N time domain symbols and M PRBs in the frequency domain, and each of the at least one repetition, each Zadoff-chu sequence of the at least one Zadoff-chu is mapped via frequency first and time second. In certain embodiments, a resource pool, a positioning frequency layer, a carrier, or some combination thereof is configured with the at least one Zadoff-chu sequence length for autonomous resource selection for PRS. In some embodiments, a first mode comprises the at least one Zadoff-chu sequence length, the cyclic shift, the PRS bandwidth, a repetition in a frequency domain and a time domain allocation, or some combination thereof.

In various embodiments, a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth. In one embodiment, a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof.

In certain embodiments, repetitions of the at least one Zadoff-chu sequence comprise different sequence lengths in a frequency domain. In some embodiments, the method 800 further comprises transmitting cyclic shift in a downlink control information (DCI) field, wherein the DCI field comprises a hybrid automatic repeat request (HARQ) process number field for PRS.

In one embodiment, an apparatus comprises a user equipment (UE). The apparatus further comprises: a receiver that receives a configuration for transmission of at least one positioning reference signal (PRS) type, wherein the configuration comprises at least one parameter comprising: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof, or some combination thereof; and a transmitter that transmits a ranging signal to at least one device, receiving a ranging signal from at least one device, or some combination thereof.

In certain embodiments, a long PRS sequence length is mapped in at least one domain symbol over a wide PRS bandwidth, and the at least one Zadoff-chu sequence is mapped via frequency first and time second.

In some embodiments, a repetition of a substantially similar Zadoff-chu sequence in a frequency domain for wide PRS transmissions, a plurality of repetitions in the frequency domain containing the at least one Zadoff-chu sequence length, or a combination thereof are grouped together.

In various embodiments, at least one repetition of the plurality of repetitions is performed using at least one different sequence length if a PRS bandwidth is not a multiple of a sequence length, and a last repetition of the plurality of repetitions is performed with a different sequence length.

In one embodiment, at least one repetition of the plurality of repetitions comprises N time domain symbols and M PRBs in the frequency domain, and each of the at least one repetition, each Zadoff-chu sequence of the at least one Zadoff-chu is mapped via frequency first and time second.

In certain embodiments, a resource pool, a positioning frequency layer, a carrier, or some combination thereof is configured with the at least one Zadoff-chu sequence length for autonomous resource selection for PRS.

In some embodiments, a first mode comprises the at least one Zadoff-chu sequence length, the cyclic shift, the PRS bandwidth, a repetition in a frequency domain and a time domain allocation, or some combination thereof.

In various embodiments, a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth.

In one embodiment, a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof.

In certain embodiments, the apparatus further comprises a processor that repeats, in the frequency domain, substantially similar Zadoff-chu sequences having the same cyclic shift.

In some embodiments, the apparatus further comprises a processor that interlaces a PRS sequence, a PRS block, or a combination thereof in the frequency domain into a plurality of interfacing blocks, and each interfacing block of the plurality of interfacing blocks comprises M PRBs, M subchannels, M REs, or some combination thereof.

In various embodiments, repetitions of the at least one Zadoff-chu sequence comprise different sequence lengths in a frequency domain.

In one embodiment, the receiver receives cyclic shift in a downlink control information (DCI) field, and the DCI field comprises a hybrid automatic repeat request (HARQ) process number field for PRS.

In one embodiment, a method in a user equipment (UE) comprises: receiving a configuration for transmission of at least one positioning reference signal (PRS) type, wherein the configuration comprises at least one parameter comprising: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof; or some combination thereof; and transmitting a ranging signal to at least one device, receiving a ranging signal from at least one device, or some combination thereof.

In certain embodiments, a long PRS sequence length is mapped in at least one domain symbol over a wide PRS bandwidth, and the at least one Zadoff-chu sequence is mapped via frequency first and time second.

In some embodiments, a repetition of a substantially similar Zadoff-chu sequence in a frequency domain for wide PRS transmissions, a plurality of repetitions in the frequency domain containing the at least one Zadoff-chu sequence length, or a combination thereof are grouped together.

In various embodiments, at least one repetition of the plurality of repetitions is performed using at least one different sequence length if a PRS bandwidth is not a multiple of a sequence length, and a last repetition of the plurality of repetitions is performed with a different sequence length.

In one embodiment, at least one repetition of the plurality of repetitions comprises N time domain symbols and M PRBs in the frequency domain, and each of the at least one repetition, each Zadoff-chu sequence of the at least one Zadoff-chu is mapped via frequency first and time second.

In certain embodiments, a resource pool, a positioning frequency layer, a carrier, or some combination thereof is configured with the at least one Zadoff-chu sequence length for autonomous resource selection for PRS.

In some embodiments, a first mode comprises the at least one Zadoff-chu sequence length, the cyclic shift, the PRS bandwidth, a repetition in a frequency domain and a time domain allocation, or some combination thereof.

In various embodiments, a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth.

In one embodiment, a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof.

In certain embodiments, the method further comprises repeating, in the frequency domain, substantially similar Zadoff-chu sequences having the same cyclic shift.

In some embodiments, the method further comprises interlacing a PRS sequence, a PRS block, or a combination thereof in the frequency domain into a plurality of interfacing blocks, and each interfacing block of the plurality of interfacing blocks comprises M PRBs, M subchannels, M REs, or some combination thereof.

In various embodiments, repetitions of the at least one Zadoff-chu sequence comprise different sequence lengths in a frequency domain.

In one embodiment, the method further comprises receiving cyclic shift in a downlink control information (DCI) field, wherein the DCI field comprises a hybrid automatic repeat request (HARQ) process number field for PRS.

In one embodiment, an apparatus comprises a network device. The apparatus further comprises: a transmitter that transmits a configuration for transmission of at least one positioning reference signal (PRS) type, wherein the configuration comprises at least one parameter comprising: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof, or some combination thereof; and a receiver that receives a ranging signal to at least one device, transmitting a ranging signal from at least one device, or some combination thereof.

In certain embodiments, a long PRS sequence length is mapped in at least one domain symbol over a wide PRS bandwidth, and the at least one Zadoff-chu sequence is mapped via frequency first and time second.

In some embodiments, a repetition of a substantially similar Zadoff-chu sequence in a frequency domain for wide PRS transmissions, a plurality of repetitions in the frequency domain containing the at least one Zadoff-chu sequence length, or a combination thereof are grouped together.

In various embodiments, at least one repetition of the plurality of repetitions is performed using at least one different sequence length if a PRS bandwidth is not a multiple of a sequence length, and a last repetition of the plurality of repetitions is performed with a different sequence length.

In one embodiment, at least one repetition of the plurality of repetitions comprises N time domain symbols and M PRBs in the frequency domain, and each of the at least one repetition, each Zadoff-chu sequence of the at least one Zadoff-chu is mapped via frequency first and time second.

In certain embodiments, a resource pool, a positioning frequency layer, a carrier, or some combination thereof is configured with the at least one Zadoff-chu sequence length for autonomous resource selection for PRS.

In some embodiments, a first mode comprises the at least one Zadoff-chu sequence length, the cyclic shift, the PRS bandwidth, a repetition in a frequency domain and a time domain allocation, or some combination thereof.

In various embodiments, a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth.

In one embodiment, a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof.

In certain embodiments, repetitions of the at least one Zadoff-chu sequence comprise different sequence lengths in a frequency domain.

In some embodiments, the transmitter transmits cyclic shift in a downlink control information (DCI) field, and the DCI field comprises a hybrid automatic repeat request (HARQ) process number field for PRS.

In one embodiment, a method in a network device comprises: transmitting a configuration for transmission of at least one positioning reference signal (PRS) type, wherein the configuration comprises at least one parameter comprising: a PRS bandwidth; a number of time domain symbol for PRS transmission in a slot; a mapping type comprising at least one Zadoff-chu sequence length for: at least one frequency domain repetition; a number of repetitions; a cyclic shift; or some combination thereof or some combination thereof and receiving a ranging signal to at least one device, transmitting a ranging signal from at least one device, or some combination thereof.

In certain embodiments, a long PRS sequence length is mapped in at least one domain symbol over a wide PRS bandwidth, and the at least one Zadoff-chu sequence is mapped via frequency first and time second.

In some embodiments, a repetition of a substantially similar Zadoff-chu sequence in a frequency domain for wide PRS transmissions, a plurality of repetitions in the frequency domain containing the at least one Zadoff-chu sequence length, or a combination thereof are grouped together.

In various embodiments, at least one repetition of the plurality of repetitions is performed using at least one different sequence length if a PRS bandwidth is not a multiple of a sequence length, and a last repetition of the plurality of repetitions is performed with a different sequence length.

In one embodiment, at least one repetition of the plurality of repetitions comprises N time domain symbols and M PRBs in the frequency domain, and each of the at least one repetition, each Zadoff-chu sequence of the at least one Zadoff-chu is mapped via frequency first and time second.

In certain embodiments, a resource pool, a positioning frequency layer, a carrier, or some combination thereof is configured with the at least one Zadoff-chu sequence length for autonomous resource selection for PRS.

In some embodiments, a first mode comprises the at least one Zadoff-chu sequence length, the cyclic shift, the PRS bandwidth, a repetition in a frequency domain and a time domain allocation, or some combination thereof.

In various embodiments, a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth.

In one embodiment, a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof.

In certain embodiments, repetitions of the at least one Zadoff-chu sequence comprise different sequence lengths in a frequency domain.

In some embodiments, the method further comprises transmitting cyclic shift in a downlink control information (DCI) field, wherein the DCI field comprises a hybrid automatic repeat request (HARQ) process number field for PRS.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration for transmission of at least one positioning reference signal (PRS) type, wherein the configuration comprises at least one parameter comprising:
a PRS bandwidth;
a number of time domain symbol for PRS transmission in a slot;
a mapping type comprising at least one Zadoff-chu sequence length for:
at least one frequency domain repetition;
a number of repetitions;
a cyclic shift;
or a combination thereof;
or a combination thereof; and
transmit a ranging signal to at least one device, receiving a ranging signal from at least one device, or a combination thereof.

2. The UE of claim 1, wherein a long PRS sequence length is mapped in at least one domain symbol over a wide PRS bandwidth, and the at least one Zadoff-chu sequence is mapped via frequency first and time second.

3. The UE of claim 1, wherein a repetition of a substantially similar Zadoff-chu sequence in a frequency domain for wide PRS transmissions, a plurality of repetitions in the frequency domain containing the at least one Zadoff-chu sequence length, or a combination thereof are grouped together.

4. The UE of claim 3, wherein at least one repetition of the plurality of repetitions is performed using at least one different sequence length if a PRS bandwidth is not a multiple of a sequence length, and a last repetition of the plurality of repetitions is performed with a different sequence length.

5. The UE of claim 3, wherein at least one repetition of the plurality of repetitions comprises N time domain symbols and M PRBs in the frequency domain, and each of the at least one repetition, each Zadoff-chu sequence of the at least one Zadoff-chu is mapped via frequency first and time second.

6. The UE of claim 1, wherein a resource pool, a positioning frequency layer, a carrier, or a combination thereof is configured with the at least one Zadoff-chu sequence length for autonomous resource selection for PRS.

7. The UE of claim 1, wherein a first mode comprises the at least one Zadoff-chu sequence length, the cyclic shift, the PRS bandwidth, a repetition in a frequency domain and a time domain allocation, or a combination thereof.

8. The UE of claim 1, wherein a Zadoff-chu sequence of the at least one Zadoff-chu sequence is mapped in one time domain symbol starting from a first subcarrier via frequency first and time second in response to the Zadoff-chu sequence length being less than or equal to the PRS bandwidth.

9. The UE of claim 1, wherein a Zadoff-chu sequence of the at least one Zadoff-chu sequence is mapped via frequency first and time second in a plurality of time domain symbols in response to the Zadoff-chu sequence length being greater than available resource elements (REs) for PRS mapping in a symbol, in the PRS bandwidth, or a combination thereof.

10. The UE of claim 1, wherein the at least one processor is configured to cause the UE to repeat, in the frequency domain, substantially similar Zadoff-chu sequences having the same cyclic shift.

11. The UE of claim 1, wherein the at least one processor is configured to cause the UE to interlace a PRS sequence, a PRS block, or a combination thereof in the frequency domain into a plurality of interfacing blocks, and each interfacing block of the plurality of interfacing blocks comprises M PRBs, M subchannels, M REs, or a combination thereof.

12. The UE of claim 1, wherein repetitions of the at least one Zadoff-chu sequence comprise different sequence lengths in a frequency domain.

13. The UE of claim 1, wherein the at least one processor is configured to cause the UE to receive cyclic shift in a downlink control information (DCI) field, and the DCI field comprises a hybrid automatic repeat request (HARD) process number field for PRS.

14. A processor for wireless communication, comprising:
at least one controller coupled with at least one memory and configured to cause the processor to:
receive a configuration for transmission of at least one positioning reference signal (PRS) type, wherein the configuration comprises at least one parameter comprising:
a PRS bandwidth;
a number of time domain symbol for PRS transmission in a slot;
a mapping type comprising at least one Zadoff-chu sequence length for:
at least one frequency domain repetition;
a number of repetitions;
a cyclic shift;
or a combination thereof;
or some a combination thereof; and
transmit a ranging signal to at least one device, receiving a ranging signal from at least one device, or a combination thereof.

15. An apparatus for performing a network function, the apparatus comprising:
at least one memory; and
at least one processor coupled with the at least one memory and configured to cause the apparatus to:
transmit a configuration for transmission of at least one positioning reference signal (PRS) type, wherein the configuration comprises at least one parameter comprising:
a PRS bandwidth;
a number of time domain symbol for PRS transmission in a slot;
a mapping type comprising at least one Zadoff-chu sequence length for:
at least one frequency domain repetition;
a number of repetitions;
a cyclic shift;
or a combination thereof;
or some a combination thereof; and
receive a ranging signal to at least one device, transmitting a ranging signal from at least one device, or a combination thereof.

16. The processor of claim 14, wherein a long PRS sequence length is mapped in at least one domain symbol over a wide PRS bandwidth, and the at least one Zadoff-chu sequence is mapped via frequency first and time second.

17. The processor of claim 14, wherein a repetition of a substantially similar Zadoff-chu sequence in a frequency domain for wide PRS transmissions, a plurality of repetitions in the frequency domain containing the at least one Zadoff-chu sequence length, or a combination thereof are grouped together.

18. The processor of claim 17, wherein at least one repetition of the plurality of repetitions is performed using at least one different sequence length if a PRS bandwidth is not a multiple of a sequence length, and a last repetition of the plurality of repetitions is performed with a different sequence length.

19. The processor of claim 17, wherein at least one repetition of the plurality of repetitions comprises N time domain symbols and M PRBs in the frequency domain, and each of the at least one repetition, each Zadoff-chu sequence of the at least one Zadoff-chu is mapped via frequency first and time second.

20. A method performed by a user equipment (UE), the method comprising:
receiving a configuration for transmission of at least one positioning reference signal (PRS) type, wherein the configuration comprises at least one parameter comprising:
a PRS bandwidth;
a number of time domain symbol for PRS transmission in a slot;
a mapping type comprising at least one Zadoff-chu sequence length for:
at least one frequency domain repetition;
a number of repetitions;
a cyclic shift;
or a combination thereof;
or a combination thereof; and
transmitting a ranging signal to at least one device, receiving a ranging signal from at least one device, or a combination thereof.
